(19) United States
(12) Patent Application Publication
(10) Pub. No.: US 2024/0092274 A1
(43) Pub. Date: Mar. 21, 2024

(54) HOLDER FRAME AND HOLDER FOR VEHICLE COMPRISING SAME

(71) Applicant: Jung Won LEE, Gangwon-do (KR)

(72) Inventor: Jung Won LEE, Gangwon-do (KR)

(21) Appl. No.: 18/255,427

(22) PCT Filed: Nov. 25, 2021
(86) PCT No.: PCT/KR2021/017454

§ 371 Date: Jun. 1, 2023

(30) Foreign Application Priority Data
Dec. 2, 2020 (KR) 10-2020-0166845

(51) Int. Cl. B60R 11/00

(52) U.S. Cl. CPC B60R 11/00; B60R 2011/0005; B60R 2011/0071

(57) ABSTRACT

Proposed is a holder frame having a holder for fixing an article in a vehicle. The holder frame includes a fixing clip configured to be fitted between a windshield and a dashboard of a vehicle and configured to be fixed by opening elasticity between the windshield and the dashboard of the vehicle, and a dashboard frame composed of a first section coupled to a bottom of the fixing clip, a body extending from the first section across a dashboard of a vehicle, and a second section to which a holding unit for holding an object can be coupled. The fixing clip is provided in an open structure of which both ends opening at an acute angle are spaced apart from each other, thereby being able to additionally fix an article that is held inside a windshield.

### FIELD OF INVENTION

The present disclosure relates to a holder frame that fixes automotive articles using the windshield and the dashboard of a vehicle, and a holder for a vehicle comprising the holder frame.

### BACKGROUND ART

In general, various articles that a driver or passengers need such as a sticker, a promotional material, a Hi-pass, a parking pass, a navigation device, and a smartphone are kept around the windshield or the driver seat in vehicles. Since there are various articles that need to be fixed, the kinds of holders are also varied such as a smartphone holder, a tablet PC holder, and a Hi-pass holder.

Existing holders are slightly not enough to completely fix various articles. Existing holders may not fully show their functions due to external factors that are applied to a vehicle such as high temperature and impact or an accident may be generated anytime due to falling during driving.

The limitation of the fixing type of an adhesive tape, a suctioner (suction rubber), etc. may be considered as a factor that reduces the satisfaction of customers with holder products. An adhesive tape is loosened at high temperature or the adhesive force thereof naturally decreases over time, which results in falling of installed articles. Further, such an adhesive tape is easy to installed, but difficult to remove, so it may damage a vehicle such as tearing a tinting film. A suctioner (suction rubber) also has a problem that it is vulnerable to high temperature and damages a leather dash board. The type of fixing a holder to a vent has problems that it is not available for some kinds of vehicles, makes a vent itself unavailable, deteriorates the performance of a vent, breaks the blades of a vent, or generates noise due to vibration of a vehicle.

Accordingly, there is a need for a new fixing type that can improve satisfaction of customers by improving and supplementing the fixing types of the related art. As a patent document related to this matter, a wedge-type clamp has been disclosed in Korean Patent Application Publication No. 10-2013-0137894. The prior patent solves the problems of the fixing types of the related art by proposing a configuration of a clamp that is fixed by friction between the windshield and the dashboard of a vehicle. The clamp disclosed in the prior patent proposes a hinge-clamp structure using friction, but does not a holder unit that the space between the windshield and the dashboard in a vehicle can use.

Accordingly, the applicant(s) has designed a holder frame that can fix all of cards that are suitable to be held on the windshield of a vehicle and devices that can be held in front of the dashboard such as a smartphone and a navigation device while solving the problems of the fixing types of the related art, and a holder for a vehicle comprising the holder frame.

### PATENT DOCUMENT

(Patent Document 1) Korean Patent Application Publication No. 10-2013-0137894

### DISCLOSURE

### Technical Problem

An objective of the present disclosure is to provide a holder frame that can stably fix a holder for fixing interior articles of vehicles without damaging vehicles and that can hold both of small articles such as cards and heavy articles such as terminals, and a holder for a vehicle comprising the holder frame.

### Technical Solution

In order to achieve the objectives, the present disclosure is characterized in that a holder frame having a holder for fixing an article in a vehicle includes: a fixing clip configured to be fitted between a windshield and a dashboard of a vehicle and configured to be fixed by opening elasticity between the windshield and the dashboard of the vehicle; and a dashboard frame composed of a first section coupled to a bottom of the fixing clip, a body extending from the first section across a dashboard of a vehicle, and a second section to which a holding unit for holding an object can be coupled, in which the fixing clip is provided in an open structure of which both ends opening at an acute angle are spaced apart from each other, thereby being able to additionally fix an article that is held inside a windshield.

The holder frame according to the present disclosure may further include a friction member disposed on a first free section of the fixing clip that is configured to come in close contact with an inner surface of a windshield, and the friction member may have: a non-slip pad portion configured to increase friction in contact with an inner surface of the windshield; and a fixing portion formed at a first free section of the fixing clip and configured to fix an article such as a card.

The body of the dashboard frame may be made of a material having predetermined strength and extends in a line, and the first section coupled to the bottom of the fixing clip may bend with a positive curvature from the body and increase a fixing force of the fixing clip.

The dashboard frame may have a length adjuster configured to adjust a length of the body.

Further, the present disclosure is characterized in that a holder for a vehicle that is mounted on a dashboard of a vehicle and fixes an article includes: a fixing clip configured to be fitted between a windshield and a dashboard of a vehicle and configured to be frictionally fixed by opening elasticity between the windshield and the dashboard of the vehicle; a dashboard frame composed of a first section coupled to a bottom of the fixing clip, a body extending from the first section across a dashboard of a vehicle, and a second section formed at an end of the body; and a holding unit installed at the second section of the dashboard frame and having a housing configured to fix an article.

### Advantageous Effects

According to the present disclosure, since a fixing clip having opening elasticity of a plate-shape spring is fitted in an acute angle made by the windshield and the dashboard of a vehicle, a stable fixing force can be maintained even though a vehicle is driven or environments such as temperature change.

According to the present disclosure, since a fixing force is applied to the holder frame with the free sections of the fixing clips open, there is an advantage of being able to use the space between the windshield and the dashboard of a vehicle in which the fixing clip is disposed. In this case, there is a structural advantage that it is possible to additionally provide not only the holding unit that is installed on a dashboard, but a fixing portion, which makes it easy to keep small cards such as a Hi-pass card and a parking pass, at the fixing clip disposed on a windshield.

### DESCRIPTION OF DRAWINGS

FIG. 1 shows the configuration of a holder for a vehicle comprising a holder frame according to an embodiment of the present disclosure.

FIG. 2 shows a fixing clip and a friction member according to another embodiment of the present disclosure.

### DESCRIPTION OF REFERENCE NUMERALS

1: holder for vehicle
10: holder frame
11: fixing clip
13: dashboard frame
131: first section
1311: protruding fixing portion
133: body
1330: length adjuster
135: second section
110, 1310: non-slip pad
30: holding unit
50: card holder
60: height adjuster
70: friction member
71: non-slip pad portion
73,75: fixing portion

### MODE FOR INVENTION

Hereafter, the present disclosure is described in detail with reference to the matters in the accompanying drawings. However, the present disclosure is not limited to exemplary embodiments. The same reference numerals in the drawings indicate components that perform substantially the same functions.

The objectives and effects of the present disclosure can be naturally understood or made clearer by the following description, but are not limited only to the following description. Further, in description of the present disclosure, well-known technologies are not described in detail not to obscure the description of the present disclosure with unnecessary detail.

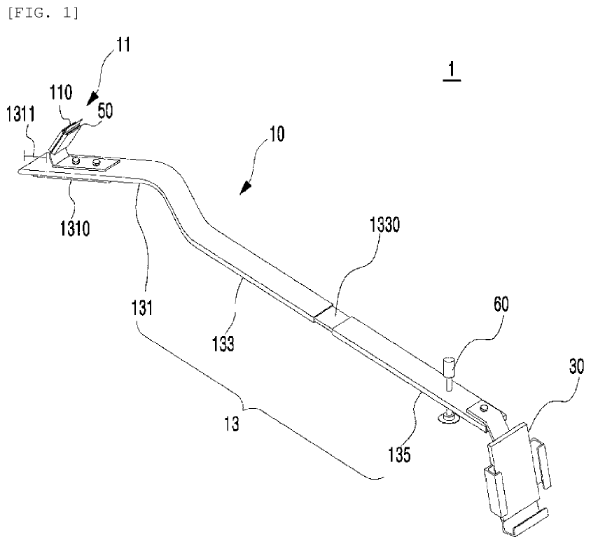

FIG. 1 shows the configuration of a holder 1 for a vehicle comprising a holder frame 10 according to an embodiment of the present disclosure. Referring to FIG. 1, the holder 1 for 1 vehicle according to the embodiment may include a holder frame 10 and a holding unit 30.

The holder frame 10 may include a fixing clip 11 and a dashboard frame 13. The windshield and the dashboard of a vehicle make about an angle of 35°. The holder frame 10 according to this embodiment is a plate spring member having an angle larger than 35° at the joint of a windshield and a dashboard of a vehicle and proposes a fixing type of being frictionally fixed at the joint of a windshield and a dashboard by opening elasticity.

Since the holder frame 10 according to this embodiment does not employ adhesion or the fixing type of a suctioner, its fixing force is maintained even though variation of environments such as temperature and there is an advantage that the holder frame 10 does not spoil the interior environment of a vehicle even though it is removed. Further, the holder frame 10 according to this embodiment can function as a general holder that can hold terminals such as a smartphone, a tablet PC, and a navigation device that are placed around a driver seat and fix small cards such as a Hi-pass card and a parking pass that are placed inside a windshield. Hereafter, the detailed configuration of the holder frame 10 is described.

The fixing clip 11 is fitted between the windshield and the dashboard of a vehicle and is fixed by opening elasticity between the windshield and the dashboard of the vehicle. The fixing clip 11 may be an expandable plate spring member forming an acute angle of 35° or more.

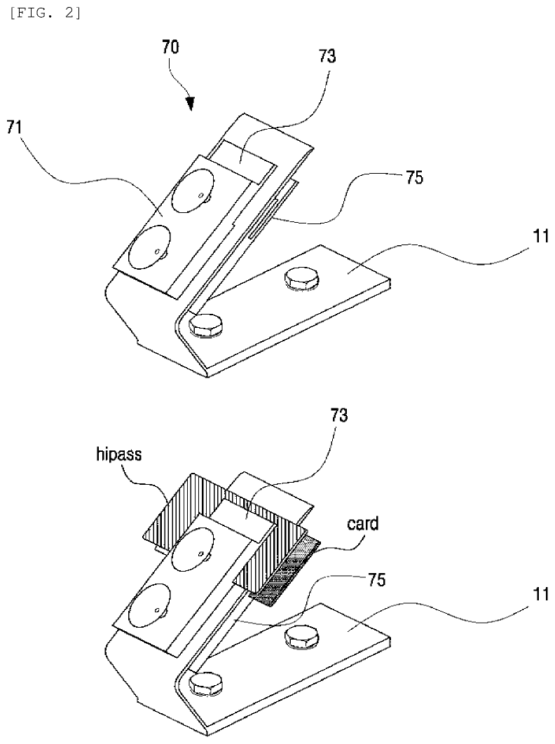

The fixing clip 11 has both free sections that are opened. A first free section that comes in contact with the windshield of a vehicle may have a non-slip pad 110 on the outer surface. The non-slip pad 110 may be a common non-slip member such as synthetic rubber having high friction. A non-slip pad 110 is directly disposed on the outer surface of the fixing slip 11 in the embodiment shown in FIG. 1, but, as shown in FIG. 2, a separate friction member 70 may be coupled.

The fixing clip 11 according to this embodiment is a simple plate spring-type member bending at an acute angle at the center, so it has an open structure of which both free sections opening at an acute angle are spaced apart from each other. Such a fixing structure of the fixing clip 11 provides a space in which articles that are held inside a windshield can be additionally fixed. That is, since the fixing clip 11 according to this embodiment has an open structure of which the ends of both free sections opening at an acute angle are spaced apart from each other, when it is fixed in a vehicle, it is possible to use a space having an acute angle.

Since the space having an acute angle by the fixing clip 11 is open, a card holder 50 for fixing cards, etc. may be provided inside the first free section that comes in contact with the windshield of a vehicle. According to this embodiment, the card holder 50 may be coated with an adhesive material so that cards such as a Hi-pass card or a parking pass are fixed in an attachment type, or may be cut to have a slit so that cards are fixed in a fitting type.

A fastening portion for coupling to the dashboard frame 13 to be described below may be formed at the second free section of the fixing clip 11 that comes in contact with a dashboard. The second section of the fixing clip 11 may have a thread groove or an adhesive fastening member for adhesive coupling as a part for coupling to a first end 131 of the dashboard frame 13.

FIG. 2 shows a fixing clip 11 and a friction member 70 according to another embodiment of the present disclosure. The embodiment shown in FIG. 2 is an example in which an additional molding part is fastened to the fixing clip 11 to expand articles to be held, in which the fixing clip 11 is provided in a simple structure, thereby showing the advantage of using a fixing structure for general purposes.

Referring to FIG. 2, the dashboard frame 10 may further include a friction member 70 fastened to the fixing clip 11.

The friction member 70 is disposed on a first free section of the fixing clip 11 that comes in close contact with the inner surface of a windshield. The friction member 70 may have a housing structure having an open side to be fitted on the first free section of the fixing clip 11.

The friction member 70 may have a non-slip pad portion 71 and fixing portions 73 and 75. The non-slip pad portion 71 is disposed on the outer surface of the friction member 70 and may have the non-slip pad 110 described above. The non-slip pad portion 71 can increase friction by coming in contact with the inner surface of a windshield. The first free section of the fixing clip 11 is fixed to a windshield by the friction of the non-slip pad portion 71 and the second free section of the fixing clip 11 is fixed to a dashboard by the friction of the dashboard frame 13.

The fixing portions 73 and 75 can fix articles such as cards at the first free section of the fixing clip. A first fixing portion 73, which is a region in which the non-slip pad 71 extends, may form a small groove together with the first free section of the fixing clip 11. Articles such as cards can be inserted and kept in the groove formed by the first fixing portion 73 and the first free section of the fixing clip 11. A second fixing portion 75 is a protruding region that forms a small slit inside the first free section of the fixing clip 11. The second fixing portion 75 enables cards to be inserted and kept in a slit formed inside the first free section.

The first fixing portion 73 may be slightly inconvenient for a user to insert cards, but fixed cards are directly exposed forward through the windshield of a vehicle, so a card for parking recognition, a sticker for showing vehicle information, a promotional card, etc. can be kept. Since the second fixing portion 75 is disposed at a position at which a user can easily take out cards in a vehicle, a Hi-pass card, etc. that need to be replaced often may be kept.

Referring to FIG. 1 again, the dashboard frame 13 has a first section coupled to the bottom of the fixing clip 11, a body 133 extending from the first section 131 across the dashboard of a vehicle, and a second section 135 to which the holding unit 30 holding an object can be coupled.

The first section 131 of the dashboard frame 13 is coupled to the second free section of the fixing clip 11. The first section 131 of the dashboard frame 13 may have a non-slip pad 1310 on the bottom. In this case, the non-slip pad 1310 may be implemented by attaching a specific synthetic rubber material, but a non-slip function may be provided using the structure of the material of the dashboard frame 13 or structural characteristics such as a prominence-recession structure.

As this embodiment, when the first section 131 of the dashboard frame 13 is coupled to the second free section of the fixing clip 11, a protruding fixing portion 1311 extending further than the fixing end of the fixing clip 11 may be provided. The protruding fixing portion 1311 is a region additionally protruding from the rearmost end of the fixing clip 11. The protruding fixing portion 1311 can be naturally formed by adjusting the position at which the second free section of the fixing clip 11 and the first section 131 of the dashboard frame 13 are coupled. When the fixing clip 11 is fitted between the windshield and the dashboard of a vehicle, the protruding fixing portion 1311 is fitted to the innermost side between the windshield and the dashboard, thereby keeping the fixing clip 11 stably inserted and fixed.

As this embodiment, the first section 131 coupled to the bottom of the fixing clip 11 bends with a positive curvature from the body 133, thereby being able to increase the fixing force of the fixing clip 11. The first section 131 of the dashboard frame 13 forms an additional bend, thereby pressing the fixing clip 1 upward when the dashboard frame 13 is fixed in surface contact with a dashboard. The fixing clip 11 is pressed upward by the structural curvature of the dashboard frame 13, thereby being able to further increase a friction contact force with a windshield.

As this embodiment, the end of the first section 131 of the dashboard frame 13 is chamfered or rounded for smooth insertion and is covered with a material such as a rubber packing, so the first section 131 is fitted under strong friction between a windshield and a dashboard without spoiling the interior of a vehicle.

The body 133 of the dash board frame 13 is made of a material having predetermined strength and extends in a line shape. A length adjuster 1330 that adjusts the length of the 133 of the dash board frame 13 may be formed. The dashboards of vehicles have different widths in accordance the kinds of the vehicles. The dashboard frame 13 may be designed in a shape fitting to the curve and width of the dashboard in accordance with the kind of each vehicle, but a specific length adjuster 1330 may be provided for general use. The length adjuster 1330 can increase or decrease the length of the body 133 by sliding predetermined distances in a longitudinal direction.

As this embodiment, a height adjuster 60 may be disposed at the second section 135 of the dashboard frame 13. The height adjuster 60 can space the second section 135 of the dashboard frame 13 a predetermined distance from a dashboard. As noticeable point, the dashboard frame 13 according to this embodiment may be formed such that the bottom thereof is spaced a predetermined distance from a dashboard. Friction noise due to vibration may be generated when a vehicle is driven unless the dashboard frame 13 is in completely close contact with the dashboard of the vehicle. Accordingly, the dashboard frame 13 is provided in the structure in which the body 133 thereof is spaced a predetermined distance from a dashboard, and the first section 131 and the second section 135 of the dashboard frame 13 form fixing contact points in the dashboard of a vehicle. Accordingly, the first section 131 of the dashboard frame 13 smoothly bends with the end thereof facing down.

The holding unit 30 may be installed at the second section 135 of the dashboard frame 10 and may have a housing fixing an article. The holding unit 30 may have a common housing for holding devices like terminals such as a smartphone, a tablet PC, and a navigation device.

Although the present disclosure were described above through representative embodiments, those skilled in the art will understand that the embodiments may be modified in various ways without departing from the scope of the present disclosure. Therefore, the copyright range of the present disclosure should not be determined only by the embodiments described above and should be determined by not only claims to be described below, but all of changed and modified examples derived from the equivalent concept as the claims.

### INDUSTRIAL APPLICABILITY

According to the present disclosure, a holder for fixing an interior article for a vehicle can be stably fixed without spoiling the vehicle and can hold small articles such as cards and heavy articles such as terminals.

1. A holder frame having a holder for fixing an article in a vehicle, the holder frame comprising:
a fixing clip configured to be fitted between a windshield and a dashboard of a vehicle and configured to be fixed by opening elasticity between the windshield and the dashboard of the vehicle; and
a dashboard frame composed of a first section coupled to a bottom of the fixing clip, a body extending from the first section across a dashboard of a vehicle, and a second section to which a holding unit for holding an object can be coupled,
wherein the fixing clip is provided in an open structure of which both ends opening at an acute angle are spaced apart from each other, so a space having an acute angle can be used when the fixing clip is fixed to a vehicle.

2. The holder frame of claim 1, further comprising a friction member disposed on a first free section of the fixing clip that is configured to come in close contact with an inner surface of a windshield,
wherein the friction member has:
a non-slip pad portion configured to increase friction in contact with an inner surface of the windshield; and
a fixing portion formed at a first free section of the fixing clip and configured to fix an article such as a card.

3. The holder frame of claim 1, wherein the body of the dashboard frame is made of a material having predetermined strength and extends in a line, the first section coupled to the bottom of the fixing clip bends with a positive curvature from the body and increases a fixing force of the fixing clip.

4. The holder frame of claim 1, wherein the dashboard frame has a length adjuster configured to adjust a length of the body.

5. A holder for a vehicle that is mounted on a dashboard of a vehicle and fixes an article, the holder comprising:
a fixing clip configured to be fitted between a windshield and a dashboard of a vehicle and configured to be frictionally fixed by opening elasticity between the windshield and the dashboard of the vehicle;
a dashboard frame composed of a first section coupled to a bottom of the fixing clip, a body extending from the first section across a dashboard of a vehicle, and a second section formed at an end of the body; and
a holding unit installed at the second section of the dashboard frame and having a housing configured to fix an article.
